(19) United States
(12) Patent Application Publication
(10) Pub. No.: US 2021/0059460 A9
(43) Pub. Date: Mar. 4, 2021

(54) EVAPORATOR DEVICE, AND ELECTRICAL APPLIANCE HAVING AN EVAPORATOR DEVICE

(71) Applicant: E.G.O. Elektro-Geraetebau GmbH, Oberderdingen (DE)

(72) Inventors: Tobias Albert, Kraichtal (DE); Volker Block, Bretten (DE); Sebastian Eigl, Bretten (DE); Roland Muehlnikel, Bretten (DE); Konrad Schoenemann, Sulzfeld (DE); Michael Tafferner, Malsch (DE)

(21) Appl. No.: 16/589,407

(22) Filed: Oct. 1, 2019

(30) Foreign Application Priority Data
Oct. 15, 2018 (DE) 10 2018 217 645.0

(51) Int. Cl. A47J 27/04; A47J 27/00

(52) U.S. Cl. CPC A47J 27/04; A47J 2027/043; A47J 27/004

(57) ABSTRACT

An evaporator device for water, which is intended to produce steam for, for example, a steam cooking device, has a container which is closed apart from a water inlet and a steam outlet, and has heating elements on the outside of the container. An inner body is arranged inside the container and is, everywhere on its outer surface, which faces toward the heating element, spaced apart from the inner side of the container. Said inner body is permeable to steam and water and consists of a non-solid material or of a porous material or of a fabric material.

### CROSS-REFERENCE TO RELATED APPLICATIONS

This application claims priority to German Application No. 10 2018 217 645.0, filed Oct. 15, 2018, the contents of which are hereby incorporated herein in its entirety by reference.

### BACKGROUND

The invention relates to an evaporator device for water, which has a container. Situated therein is water, which is heated by a heating element and escapes as steam. Said steam can be used for various purposes, in particular for an electrical appliance as a steam cooking appliance. The invention also relates to an electrical appliance having such an evaporator device.

A generic evaporator device for a steam cooking appliance is known from US 2016/0316516 A1. Said evaporator device has a container in the form of a round tube which stands upright and on the outside of which heating elements are arranged in three separate heating circuits. The heating power used can be very high so as to be able to produce as much steam as possible. Said steam then escapes from the container at the top.

### BRIEF SUMMARY

The invention is based on the object of providing an evaporator device for water, as mentioned in the introduction, and a corresponding electrical appliance, by way of which problems of the prior art can be resolved and it is in particular possible for water to be heated rapidly and efficiently or to be made to evaporate and for the steam here to be used in an electrical appliance.

Said object is achieved by an evaporator device having the features of claim 1, and by an electrical appliance having the features of claim 23. Advantageous and preferred configurations of the invention form the subject matter of the further claims and will be discussed in more detail below. Here, some of the features are discussed only for an evaporator device or only for an electrical appliance provided therewith. However, they are intended to be applicable, independently of this, both to an evaporator device and to a corresponding electrical appliance separately and independently of one another. The wording of the claims is incorporated into the content of the description by express reference.

The evaporator device, by which water is intended to be evaporated, has a container for the water and has at least one heating element. The container is closed apart from a water inlet and a steam outlet, there preferably being in each case only a single water inlet and/or a single steam outlet. The at least one heating element is arranged on the outside of the container, all the heating elements advantageously being arranged on the outside of the container. In the container, the water can then be heated or evaporated without the possibility of water reaching a heating element directly. Problems with electrical insulation are thus reduced.

According to the invention, an inner body is arranged inside the container and, during operation for producing steam, is advantageously surrounded at least partially, particularly advantageously completely, by water. The inner body is largely spaced apart from the inner side of the container or makes no contact therewith. Advantageously, said inner body is, on at least 80% of its outer surface, which faces toward the heating element, at a distance from the container or an inner side of the container. In this way, it is achieved that provision is made here of an at least narrow intermediate space or channel for water which can be heated and evaporated without the heating element directly heating the inner body, bearing directly against the inner side, through a casing wall of the container, which would mean an excessive flow of heat. This is then absent for evaporation of the water. It can thus be achieved that the inner body undergoes direct heating by the at least one heating element as little as possible. In regions in which no heating element is provided on an outer surface of the container, as will be discussed in further detail below, the inner body may bear against the inner side of the container. In particular, it should indeed be stable and retained in a positionally accurate manner.

The inner body is formed such that it is permeable to steam and to water. Said inner body is therefore not a pure displacement body. For this purpose, said inner body consists of a non-solid material and/or of a porous material and/or of a fabric material. Therefore, the inner body is advantageously not just a body or a formation which has a few water through-passages but otherwise is impermeable to water over significant regions of its outer surface. It has, as it were, a large number of water through-passages or is riddled with a large number of water passages. The permeability according to the invention to steam and water with the corresponding formation from the aforementioned material allows the inner body to be flowed through in a highly extensive and intense manner, whereby an excessive formation of steam bubbles can be prevented. It is likewise possible to reduce or suppress excessive bubbling of water or excessive water movements in the container, which are generated as a result of the heating and also possibly the steam bubble formation. In a narrow region between the inner body and the inner side of the container, wherever a heating element is arranged on the outer side, it is then possible for the water to be heated very rapidly by intense introduction of heat. This distance may lie in the range of a few millimetres, for example between 2 mm and 10 mm. This relatively small water volume can then be heated, and made to evaporate, rapidly by the heating element. Since the inner body is specifically intended to be permeable to steam and to water, it goes without saying that a certain exchange of heat or exchange of water also takes place on the inner side of the heated container wall. This is however reduced by the inner body, which then increases the rate of evaporation in a foreseeable manner.

The inner body is advantageously not solid, by virtue of the water through-passages alone. However, it is, as it were, of homogeneous form, that is to say its structure is largely or completely of the same form throughout. This may particularly advantageously be detached from the specific material or construction.

In a further configuration of the invention, it is an advantage if the water inlet is provided in the lower region of the container. Said water inlet is advantageously provided in a bottommost region, which for example can also improve drainage of water when this is drained through the water inlet. Thus, in addition to filling, emptying of the container is possible in an improved manner. Preferably, a water inlet is provided on a container base. If said container base is a separate part, as will be discussed as an option below, a water inlet may also be easily integrally formed. This facilitates the production of the entire evaporator device.

In one advantageous configuration of the invention, the container is a tube, in particular a cylindrical tube. Said container may be a round cylindrical tube, which may be produced and machined as simply as possible. In this way, it is also possible to reduce in the interior of the container the number of edges, projections or the like, at which temperature peaks possibly arise or which may be particularly exposed to calcification. It is easy for a heating element to be mounted on such a tube by way of known methods (see US 2016/0316516 A1, mentioned in the introduction).

The container of the evaporation device is advantageously arranged, in particular in an electrical appliance provided with the evaporation device, for example in the form of a steam cooker, such that a tube axis or longitudinal central axis of the container is vertical. Thus, as seen in the vertical direction, it is also possible for provision to be made of a circularly symmetrical evaporation device which has heating properties and evaporation properties that are distributed as uniformly as possible in terms of area and/or volume.

The container may be produced from metal, whereby both high mechanical strength and temperature resistance are provided. It is advantageously possible, for use to be made of a thick-film steel, which is provided on its outer side with insulation in a known manner before the heating element is mounted. In this respect, the heating element is advantageously a so-called film heating element or of a real form and is not just a single narrow heating conductor or heating wire. The heating element is particularly advantageously a thick-film heating element having at least one heating conductor, wherein the at least one heating conductor or multiple heating conductors may be mounted in a helical, meandering or suchlike manner in order to cover a specific area on the outer side of the container. This is however known in principle from the prior art (see US 2016/0316516 A1, mentioned in the introduction).

In general, albeit specifically when the container is produced from metal, a base part which is produced separately may be provided on the container. Said base part may then be sealingly connected to the container. It is thus also possible in a simple manner for complex shapes to be provided for the container and/or the base part. In particular if the intention is for the water inlet to be provided on the container base, it may be formed on said base part. This can particularly advantageously be realized in a simple manner by plastic injection moulding. In a way similar to that known for pumps or the like, the base part can then be sealingly connected to a casing wall of the container, even if said casing wall would also consist of plastic. Here, seals or sealing rings may be provided.

It is possible for a cover part of the container to be formed from plastic, particularly advantageously in turn as a part from plastic injection moulding. Such a cover part may be connected at the top to the casing wall of the container, with the same aspects as described above in relation to the base part. A connection may be sealing, advantageously having an additionally inserted or moulded-on seal. This can make it possible for the steam outlet to be arranged on the cover part or to be formed thereon. Such a steam outlet is then able to project from the cover part at an angle of almost 90° from a longitudinal central axis of the container. The angle may advantageously lie between 70° and 90°. In this case, the steam outlet points slightly upward above the horizontal, for example at an angle of between 2° and 15°. Advantageously, however, the steam outlet extends horizontally.

For the cover part, it may be provided that it has a lower tube portion or is of tube-like form in the lower region. Said tube portion may form an extension of the container, that is to say not directly close off the container at a top edge or at an upper boundary. Such a tube portion may extend slightly above the upper boundary of the tube, for example by 5 mm to 30 mm. The steam outlet, which projects laterally from the cover part, may be provided in said tube section. Such a laterally projecting steam outlet makes it possible for water entrained in an upward direction by the formed steam bubbles, as spray, not to be able to escape that easily. Steam which is as dry as possible is thus formed at the steam outlet.

In order to fasten the base part and the cover part to the container and, as far as possible, also to one another, it may be provided that in each case at least one fastening portion projects therefrom. Said fastening portion may advantageously project in a direction perpendicular to the longitudinal axis of the container, that is to say project laterally. The two fastening portions are then connected to one another, for example screwed together, and pressed together one on top of the other. They can thus be connected to the container to form a structural unit, in particular sealingly pressed together. Preferably, multiple fastening portions are provided on the cover part and on the base part, particularly advantageously oppositely in each case.

In a further configuration of the invention, it is possible for deflection means to be provided on an inner side of the cover part, in particular in the form of deflection plates or in the form of deflection surfaces. These may be provided in the projected extension of the steam outlet into the container, such that the extension of the steam outlet into the container, as it were, passes through a plurality, advantageously through all, of said deflection means. This gives rise to a relatively long, direct path toward the steam outlet and out therefrom for spraying water. Such water is in particular entrained by escaping steam. Escape of the water is thus significantly reduced or not possible at all. Thus, firstly the water in the container can be retained so as to be evaporated in an even better manner. Furthermore, it is possible to produce drier and thus advantageous steam, which can then be used more effectively in an aforementioned electrical appliance.

In a further embodiment of the invention, provision may be made of a retainer for the inner body in the container, which retainer keeps said inner body at the same point in a stable manner. In order for there to be as little contact as possible with the inner side of the container in the region of a heating element, a retaining projection for the inner body may be provided on the base part. This at least one retaining projection may extend upward, particularly advantageously in the form of a type of pin. Said retaining projection may extend upward over at least half the height of the container and/or half the height of the casing wall of the container. It is alternatively possible for the retaining projection to be arranged on the cover part and to point downward or toward the base part. Said retaining projection may be of cylindrical form, or alternatively of tapered form. The inner body may on the one hand, for a corresponding formation from corresponding material, be retained by being plugged in a centred manner onto such a retaining projection without the need for further auxiliary aids. It is also alternatively possible for provision to additionally be made for a type of screwing, locking or some other fixing. Preferably, provision is made in the inner body of a corresponding bore which matches the retaining projection. It is also possible for provision to be made of two such retaining projections, which then automatically bring about a fixing and prevent rotation of the inner body.

It is considered to be advantageous if the inner body is for the most part at a constant distance from the inner side of the container. This may be on at least 80% of its outer surface, which faces toward the heating element or is opposite a heating element. Such a distance may lie in the range mentioned in the introduction, that is to say amount to a few millimetres.

While the inner body is advantageously at a distance from the inner side of the container, in particular circumferentially and consequently all over, it is able to make contact with an unheated base or an unheated base part of the container. Here, said inner body may even bear thereon with a large part of its bottom side, in particular over the full area.

A height of the inner body in the evaporator device is advantageously selected such that said body ends beneath the steam outlet. Here, a distance in the vertical direction may be 5 mm to 30 mm. It is thus possible for steam to be formed in an unhindered manner in the water above the inner body too and to escape to the steam outlet. The inner body may end beneath a top edge of the casing wall of the container and/or beneath the heating element or a topmost region of the heating element. Here, a distance in the vertical direction may be at most 30 mm, advantageously at most 15 mm.

In one configuration of the invention, the inner body may contain steel wool or consist of steel wool. Here, it is particularly advantageously possible for use to be made of high-grade steel, preferably corrosion-resistant V2A or V4A high-grade steel. Alternatively, the inner body may contain foam-like or sponge-like material which is of open-pore form. This should be temperature-resistant up to 100° C., and so some plastics, but especially ceramic material, are/is suitable. Such ceramic material is also mechanically stable and permanently resistant.

In yet a further configuration of the invention, it is possible for the inner body to be a fabric or a mesh or a knit composed of threads or fibers, in particular composed of metal threads. Although this can then be similar per se to that in the aforementioned configuration with steel wool, the inner body is in this case shaped in a regular and targeted manner by way of a corresponding method.

In an advantageous embodiment of the invention, at least one temperature detection means is provided on an outer side of the container. This allows detection of an impermissibly high temperature or an impermissibly high rise in temperature in order that possible countermeasures can be taken. This may be discrete temperature sensors, which detect a temperature in a highly local manner. Additionally and/or alternatively, it is also possible for flat temperature detection means to be provided, in particular according to the aforementioned US 2016/0316516 A1.

An electrical appliance which is provided with the evaporator device according to the invention has, according to the invention, a steam treatment space. Steam can be introduced into said steam treatment space from the evaporator device, either in a target manner by way of a valve or directly. Such an electrical appliance is preferably an electrical cooking appliance, for example a steam cooker or a steamer for food preparation. Here, the evaporator device is advantageously arranged within the electrical appliance, particularly advantageously with a vertically positioned container, as has been discussed above.

These and further features will emerge not only from the claims but also from the description and the drawings, wherein the individual features may be realized in each case individually or severally in the form of sub-combinations in an embodiment of the invention and in other fields, and may constitute advantageous and independently protectable embodiments for which protection is claimed here. The division of the application into individual sections and intermediate subheadings does not mean that the statements made under these are restricted in terms of their general applicability.

### BRIEF DESCRIPTION OF THE DRAWINGS

Exemplary embodiments of the invention are schematically illustrated in the drawings and will be discussed in more detail below. In the drawings:

FIG. 1 shows a highly schematic illustration of a steam cooking appliance according to the invention having an evaporator according to the invention together with a cooking chamber,

FIG. 2 shows an illustration of an evaporator according to the invention obliquely from above,

FIG. 3 shows a section through an oblique illustration of the evaporator from FIG. 2, and

FIG. 4 shows a plan view of the sectional surface of the sectional illustration as per FIG. 3.

### DETAILED DESCRIPTION

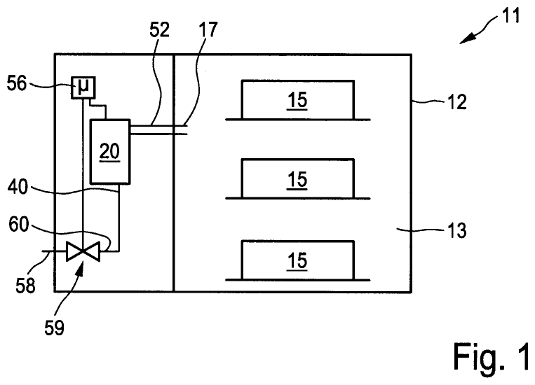

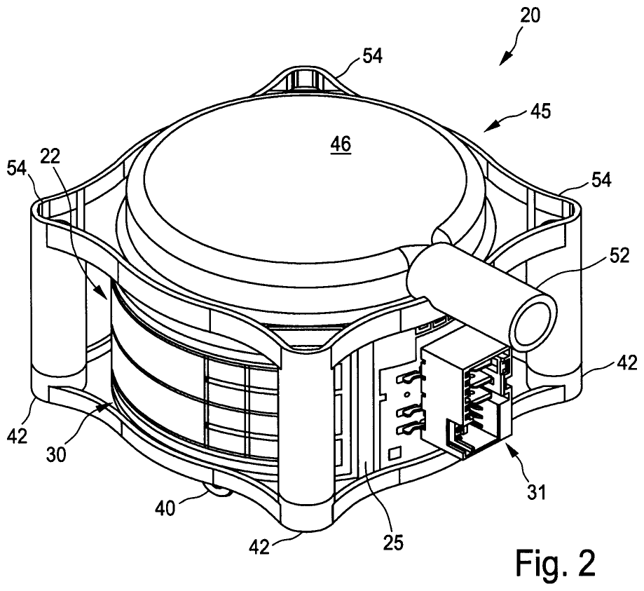

FIG. 1 highly schematically illustrates a steam cooking appliance 11, also referred to as a steamer, having a housing 12 which in particular contains a cooking chamber 13. Items for cooking 15 are contained in the cooking chamber 13 multiple times, for example in drawers one above the other, in order to be prepared by means of steam and heat. A steam inlet 17 passes into the cooking chamber 13. The steam inlet 17 comes from an evaporator 20, which will be discussed in more detail below on the basis of FIGS. 2 to 4.

The steam cooking appliance 11 has a controller 56 which is connected to an operator control unit or program unit (not illustrated). The controller 56 controls the evaporator 20, in particular the heating power thereof. Furthermore, said controller controls a valve 59 which is connected outwardly to a water connection 58 of the steam cooking appliance 11. By way of the valve 59, water can be passed in a controlled manner into the supply line 60, which leads to the evaporator 20.

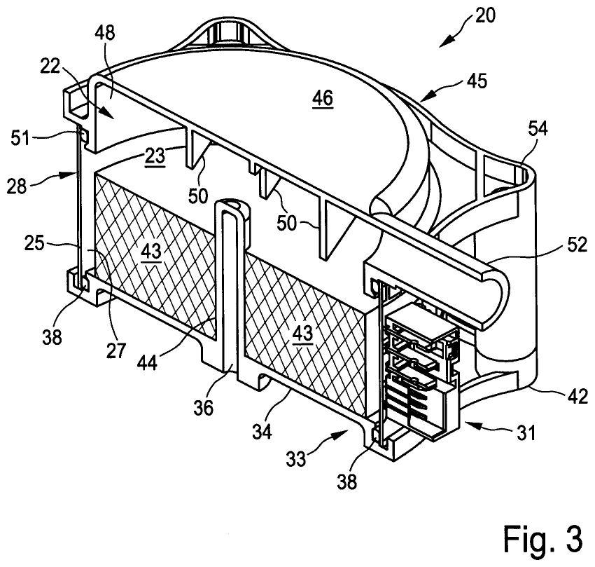

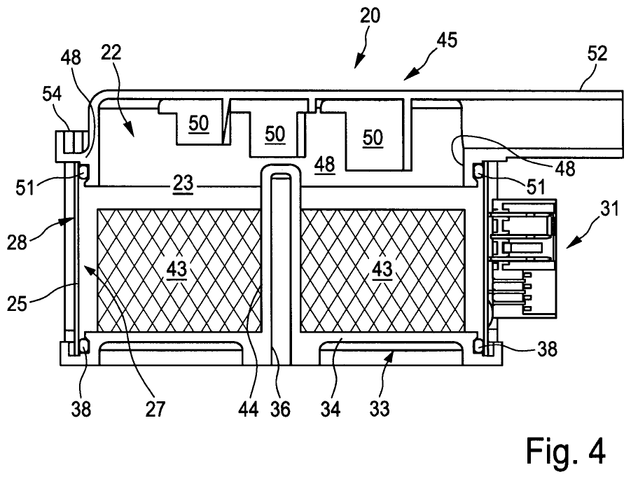

FIG. 2 illustrates an evaporator 20 according to the invention as an above-described evaporator device in an oblique view, specifically obliquely from above. The evaporator 20 will be discussed in more detail on the basis of the further FIGS. 3 and 4.

The evaporator 20 has a container 22 which has or defines an interior space 23. As will be discussed in even more detail below, during the operation of the evaporator 20, water is in said interior space 23 and is heated and evaporated. The container 22 is formed substantially by a casing wall 25 which encircles in a tube-like manner and which consists of metal. The container 22 is therefore partially formed by a tube. It has an inner side 27 and an outer side 28. Mounted on the outer side 28 is a heating conductor 30, with thick-film technology in this case, as is known for example from the aforementioned US 2016/0316516 A1. As an electrical connection to the evaporator 20, a connector plug 31 is fastened to the outer side 28. It can, by means of illustrated plug-in connector lugs, also be led to temperature sensors (not illustrated), this however being known to a person skilled in the art. The connector plug 31 is generally arranged advantageously close to the or below a steam outlet 52 which projects from a cover part 45 to the side. The casing wall 25 is advantageously formed as a round cylindrical tube which is closed in the circumferential direction and which has plane-parallel ends as a top edge at the top and a bottom edge at the bottom.

A base part 33 is arranged at the bottom of the casing wall 25 and has a substantially planar base surface 34. At the center of the base surface, provision is made of an upwardly projecting retaining projection 36 which extends over the height of the entire casing wall 25. Sealing is realized between the base part 33 and the casing wall 25 by means of a sealing ring 38 which is arranged in the region of a groove-like formation of the base part 33. As per FIG. 2, a water inlet 40 also passes into the base part 33, specifically into the base surface 34 from below. A situation is thus avoided in which the casing wall 25 has to have a hole or an aperture. Water is then able to flow into the evaporator 20, or into the container 22, from below, specifically through the base part 33 or the base surface 34 thereof.

At four opposite points, in each case one fastening portion 42 projects from the base part 33 outward. This is discussed yet further hereafter.

An inner body 43 according to the invention lies on the base surface 34 and is retained, or fixed, by the retaining projection 36, advantageously by way of clamping action. For this purpose, the inner body 43 has a corresponding inner bore 44.

As shown in particular by the lateral section in FIG. 4, the round cylindrical inner body 43, with inner bore 44 included, is formed such that its diameter is slightly smaller than the diameter of the inner side 27. Consequently, the inner body 43 is, at its outer side, always at a distance from the inner side 27 of the casing wall 25. Said distance is advantageously constant and lies in the range of the few millimetres mentioned in the introduction, for example 4 mm to 7 mm in this case. The fact that the inner body 43 does not bear against the inner side 27 means that the existence of positions of excessively varying temperature owing to different heat dissipation is prevented.

In the case in question here, the inner body 43 consists of steel wool and is pressed into shape so as to obtain the round cylindrical shape. Other materials or other forms of processing are entirely conceivable, as have been mentioned in the introduction. In any case, the inner body 43 is permeable to water and would also be permeable to steam, wherein it is advantageously largely or completely covered with water. The inner body 43 forms a narrow annular space with the inner side 27 of the casing wall 25, and the relatively small volume of water in said annular space can be correspondingly heated up by the heating conductors 30 of the heating element on the outer side 28 in a rapid manner in order to boil or in order to evaporate. Furthermore, although a certain exchange of water is ensured by the water-permeable material of the inner body 43, at the same time no excessively great exchange of water takes place. Consequently, a great exchange of water in the central region of the interior space 23 of the container 22 with water of the annular space at the inside along the inner side 27 cannot occur. Furthermore, the formation of particularly large steam bubbles can be made more difficult or prevented, which steam bubbles could likewise hinder the most rapid possible introduction of heat into the water for evaporation.

The cover part 45 is placed on the top of the casing wall 25. As can be seen, the cover part 45 is of relatively complex form and is thus advantageously produced as a plastic injection-moulded part. It has a central cover surface 46 which may be largely flat. The cover surface 46 is the upper portion of a tube portion 48 of the cover part 45, which is extended upward with a slightly smaller diameter than the casing wall 25. The tube portion 48 engages with its lower boundary into the casing wall 25, a sealing ring 51 being provided here for the purpose of sealing.

Deflection plates 50 are integrally formed on the bottom side of the cover surface 46. The deflection plates 50 extend, as can be seen from the oblique sectional illustration in FIG. 3, such that they are, as it were, situated in the path of the longitudinal central axis of the steam outlet 52. Consequently, by means of the deflection plates 50, it is possible for the escape of water droplets to the steam outlet 52 to be reduced or for a situation in which escaping steam entrains an excessive amount of these water droplets to be prevented. The deflection plates 50 become larger in the direction closer toward the steam outlet 52, since here, the risk of entrainment of water droplets increases.

Integrally formed on the cover part 45 are four corresponding fastening portions 54, which fit together with those fastening portions 42 of the base part 33. They may be either directly latched one in the other, or alternatively also additionally screwed together.

It can be seen from the oblique illustration in FIG. 2 that the evaporator 20 is relatively compact, in particular has a relatively small height. The heating element, which is formed by the heating conductors 30, may advantageously be a so-called encircling heating element. Consequently, it is switched on and switched off completely or with all of its heating conductors 30.

In addition to the long retaining projection 36, which passes through the entire inner body 43, it would also still be possible for one or two further retaining pins or the like to be arranged on the base surface 34. These could serve for the fastening or fixing of the inner body 43, such that the latter in particular cannot rotate.

A water level of water in the container 22 or in the interior space 23 should be such that, where possible, it is situated beneath the lower boundary of the cover part 45 or the tube portion 48 thereof. Above this, water would specifically actually no longer be present on the casing wall 25 or the inner side 27 of the latter, and the heating thereof from the outside by a heating conductor 30 would then also make no sense. At the same time, it is advantageous for the inner body 43 to be completely covered by water, also in order to keep the wettable surface on the inner side as large as possible or to have as much surface as possible for heating.

1. An evaporator device for water, said evaporator device having:
a container having a water inlet and a steam outlet, said container being closed apart from said water inlet and said steam outlet,
at least one heating element on an outside of said container,
wherein:
an inner body is provided, said inner body being arranged inside said container,
said inner body has an outer surface, said outer surface facing toward the heating element,
said inner body is spaced apart from said inner side of said container on at least 80% of said outer surface,
said inner body is permeable to steam and water,
said inner body consists of a non-solid material and/or of a porous material and/or of a fabric material.

2. The evaporator device as claimed in claim 1, wherein said water inlet is provided in a bottommost region of said container.

3. The evaporator device as claimed in claim 2, wherein said container is a cylindrical tube.

4. The evaporator device as claimed in claim 3, wherein said container has a tube axis, said tube axis being arranged vertical.

5. The evaporator device as claimed in claim 1, wherein said container has a circumferential casing wall of the container, said circumferential casing wall consisting of metal.

6. The evaporator device as claimed in claim 5, wherein said container has a base part, said base part being formed from plastic and being sealingly connected to said casing wall, wherein said water inlet is arranged in said base part.

7. The evaporator device as claimed in claim 5, wherein said container has a cover part, said cover part being formed from plastic and being sealingly connected at a top to said casing wall.

8. The evaporator device as claimed in claim 7, wherein said steam outlet is arranged on said cover part and projects from said cover part at an angle of between 70° and 90° from a longitudinal central axis of said container.

9. The evaporator device as claimed in claim 7, wherein said cover part extends in a lower tube portion of said container in said longitudinal direction, wherein, in said tube portion, said steam outlet projects laterally from said cover part.

10. The evaporator device as claimed in claims 6 and 7, wherein at least one fastening portion projects from said cover part, and at least one fastening portion projects from said base part, in a direction perpendicular to a longitudinal axis of said container, wherein said two fastening portions are connected to one another with a direction of force toward one another.

11. The evaporator device as claimed in claim 7, wherein said cover part has an inner side, wherein deflection plates are arranged on said inner side, said deflection plates being arranged in a projected extension of said steam outlet pointing into said container.

12. The evaporator device as claimed in claim 11, wherein said deflection plates are at a distance of at least 5 mm from said steam outlet and/or are spaced apart from one another in said projected extension.

13. The evaporator device as claimed in claim 6, wherein, from said base part, a retaining projection extends upward over at least half a height of said container or of said casing wall of said container.

14. The evaporator device as claimed in claim 1, wherein said inner body is, on at least 80% of said outer surface facing toward said heating element, at a constant distance from said inner side of said container.

15. The evaporator device as claimed in claim 14, wherein said inner body is circumferentially spaced apart from said inner side of said container.

16. The evaporator device as claimed in claim 1, wherein said inner body largely bears on a base of said container.

17. The evaporator device as claimed in claim 1, wherein said inner body ends beneath said steam outlet.

18. The evaporator device as claimed in claim 1, wherein said inner body contains steel wool or consists of steel wool.

19. The evaporator device as claimed in claim 1, wherein said inner body contains foam-like or sponge-like material which is of open-pore form.

20. The evaporator device as claimed in claim 1, wherein said inner body is a fabric or a mesh or a knit composed of metal threads.

21. The evaporator device as claimed in claim 1, wherein said heating element is in a form of a thick-film heating element.

22. The evaporator device as claimed in claim 1, wherein a temperature detection means on said outer side of said container is provided.

23. An electrical appliance having an evaporator device as claimed in claim 1 arranged therein or thereon, wherein said electrical appliance has a steam treatment space, wherein steam can be introduced into said steam treatment space from said evaporator device.

24. The electrical appliance as claimed in claim 23, wherein said electrical appliance is, as an electrical cooking appliance, a steamer for food preparation.
